(19) United States
(12) Patent Application Publication
(10) Pub. No.: US 2026/0064734 A1
(43) Pub. Date: Mar. 5, 2026

(54) KNOWLEDGE QUESTION AND ANSWER METHOD, READABLE MEDIUM AND ELECTRONIC DEVICE

(71) Applicant: Beijing Youzhuju Network Technology Co., Ltd., Beijing (CN)

(72) Inventors: Yongfu MA, Beijing (CN); Shaoyu ZHANG, Beijing (CN); Xuefeng LIU, Beijing (CN)

(21) Appl. No.: 19/296,297

(22) Filed: Aug. 11, 2025

(30) Foreign Application Priority Data
Aug. 29, 2024 (CN) 202411206262.3

(51) Int. Cl. G06F 16/3329; G06N 5/04

(52) U.S. Cl. CPC G06F 16/33295; G06N 5/04

(57) ABSTRACT

The present disclosure relates to a knowledge question and answer method, a computer-readable medium and an electronic device, the method includes: acquiring a target question input by a user in a natural language; retrieving, by a machine learning model, in a first knowledge base according to the target question to obtain a target data field for answering the target question, and retrieving in a second knowledge base according to the target question to obtain a target knowledge document for answering the target question, and determining a target answer to the target question according to the target data field and the target knowledge document, where the first knowledge base is configured to store metadata fields of a business data table composed of business data, and the second knowledge base is configured to store business knowledge documents; and displaying the target answer to the user.

### CROSS-REFERENCE TO RELATED APPLICATION

The present application claims the priority to and benefits of the Chinese Patent Application No. 202411206262.3, which was filed on Aug. 29, 2024, the entire disclosure of which is incorporated herein by reference as portion of the present application.

### TECHNICAL FIELD

The present disclosure relates to a knowledge question and answer method, an apparatus, a readable medium, an electronic device and a program product.

### BACKGROUND

Knowledge is generally divided into structured data knowledge and unstructured document knowledge. When a user wants to search for business knowledge, the user generally queries field data corresponding to the business knowledge in a data table, retrieves related documents, and then clicks on the documents one by one for reading to see if there is document knowledge related to the business knowledge.

### SUMMARY

The Summary section is provided to introduce concepts in a brief form, which will be described in detail in the Detailed Description section hereinafter. The Summary section is not intended to identify key features or essential features of the claimed technical solution, nor is it intended to be used to limit the scope of the claimed technical solution.

In a first aspect, the present disclosure provides a knowledge question and answer method, including:
acquiring a target question input by a user in a natural language;
retrieving, by a machine learning model, in a first knowledge base according to the target question to obtain a target data field for answering the target question, and retrieving in a second knowledge base according to the target question to obtain a target knowledge document for answering the target question, and determining a target answer to the target question according to the target data field and the target knowledge document, where the first knowledge base is configured to store metadata fields of a business data table composed of business data, and the second knowledge base is configured to store business knowledge documents; and
displaying the target answer to the user.

In a second aspect, the present disclosure provides a knowledge question and answer apparatus, including:
an acquisition module, configured to acquire a target question input by a user in a natural language;
a determination module, configured to retrieve, by a machine learning model, in a first knowledge base according to the target question to obtain a target data field for answering the target question, and retrieve in a second knowledge base according to the target question to obtain a target knowledge document for answering the target question, and determine a target answer to the target question according to the target data field and the target knowledge document, where the first knowledge base is configured to store metadata fields of a business data table composed of business data, and the second knowledge base is configured to store business knowledge documents; and
a display module, configured to display the target answer to the user.

In a third aspect, the present disclosure provides a computer-readable medium storing thereon a computer program which, when executed by a processing apparatus, performs the steps of any one of method according to the first aspect.

In a fourth aspect, the present disclosure provides an electronic device, including:
a storage apparatus storing thereon a computer program; and
a processing apparatus, configured to execute the computer program in the storage apparatus to implement the steps of any one of method according to the first aspect.

In a fifth aspect, the present disclosure provides a computer program product, including a computer program which, when executed by a processor, performs the steps of any one of method according to the first aspect.

### BRIEF DESCRIPTION OF DRAWINGS

The above and other features, advantages and aspects of embodiments of the present disclosure become more apparent with reference to the following detailed description and in combination with the drawings. Throughout the drawings, the same or similar reference signs refer to the same or similar elements. It should be understood that the drawings are schematic and that parts and elements are not necessarily drawn to scale. In the drawings:

FIG. 1 is a flow chart of a knowledge question and answer method according to an exemplary embodiment of the present disclosure;

FIG. 2 is a flow chart of construction of an intelligent object page according to an exemplary embodiment of the present disclosure;

FIG. 3 is a flow chart of another knowledge question and answer method according to an exemplary embodiment of the present disclosure;

FIG. 4 is a schematic diagram of a process of constructing a first knowledge base and a second knowledge base according to an exemplary embodiment of the present disclosure;

FIG. 5 is a block diagram of a knowledge question and answer apparatus according to an exemplary embodiment of the present disclosure; and

FIG. 6 is a structural diagram of an electronic device according to an exemplary embodiment of the present disclosure.

### DETAILED DESCRIPTION

The embodiments of the present disclosure will be described in more detail below with reference to the drawings. While certain embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the drawings and embodiments of the present disclosure are only for illustrative purposes, and are not intended to limit the protection scope of the present disclosure.

It should be understood that various steps recited in the method implementations of the present disclosure may be performed in different orders, and/or in parallel. In addition, the method implementations may include additional steps and/or omit performing the illustrated steps. The scope of the present disclosure is not limited in this respect.

As used herein, the term “include/comprise” and its variants are open-ended inclusions, i.e., “include/comprise but not limited to”. The term “based on” is “at least partially based on”. The term “one embodiment” represents “at least one embodiment”; the term “another embodiment” represents “at least one additional embodiment”; the term “some embodiments” represents “at least some embodiments”. Relevant definitions of other terms will be given in the following description.

It should be noted that concepts such as “first” and “second” mentioned in the present disclosure are only used to distinguish between different apparatuses, modules or units, and are not used to limit the order or interdependence of the functions performed by these apparatuses, modules or units.

It should be noted that the modifiers “one” and “a plurality of” mentioned in the present disclosure are illustrative rather than restrictive, and those skilled in the art should understand that they should be understood as “one or more” unless the context clearly indicates otherwise.

The names of messages or information exchanged between a plurality of apparatuses in the implementations of the present disclosure are only for illustrative purposes, and are not intended to limit the scope of these messages or information.

It should be understood that before using the technical solutions disclosed in the embodiments of the present disclosure, the user should be informed of the type, use scope, use scenario, etc. of the personal information involved in the present disclosure and the user's authorization should be obtained through appropriate means in accordance with relevant laws and regulations.

For example, in response to receiving an active request from the user, prompt information is sent to the user to explicitly prompt the user that the operation requested to be performed will require the acquisition and use of the user's personal information. Therefore, the user can autonomously select whether to provide personal information to software or hardware such as an electronic device, an application, a server or a storage medium that performs the operation of the technical solution of the present disclosure according to the prompt information.

As an optional but not limiting implementation, the manner of sending the prompt information to the user in response to receiving the active request from the user may be, for example, a pop-up window, and the prompt information may be presented in the pop-up window in the form of text. In addition, the pop-up window may also carry a selection control for the user to select “agree” or “disagree” to provide personal information to the electronic device.

It should be understood that the above process of notifying and obtaining user authorization is only illustrative, and does not constitute a limitation on the implementations of the present disclosure, and other manners that meet relevant laws and regulations can also be applied to the implementations of the present disclosure.

At the same time, it should be understood that data involved in the technical solution (including but not limited to the data itself, and the acquisition or use of the data) should comply with the requirements of corresponding laws, regulations and relevant provisions.

Business knowledge is generally divided into structured data knowledge such as fields in a database table, and unstructured document knowledge in various documents. When a user wants to search for business knowledge, the user generally queries field data corresponding to the business knowledge in a data table, retrieves related documents, and then clicks on the documents one by one for reading to see if there is document knowledge related to the business knowledge.

When a user wants to know the meaning of a certain word, the user needs to search for a corresponding field of the word in the data table in the data knowledge, retrieve a knowledge document related to the word in the document knowledge, and then click on the documents one by one for reading to see if there is relevant content explaining the word in the knowledge document. The operation is complex, which not only has low efficiency of acquiring knowledge, but also requires the user to manually combine and organize the data knowledge and the document knowledge, and the accuracy of the final result cannot be guaranteed.

In view of this, the present disclosure provides a knowledge question and answer method, an apparatus, a readable medium, an electronic device and a program product to solve the above technical problem.

The embodiments of the present disclosure will be further explained below with reference to the drawings.

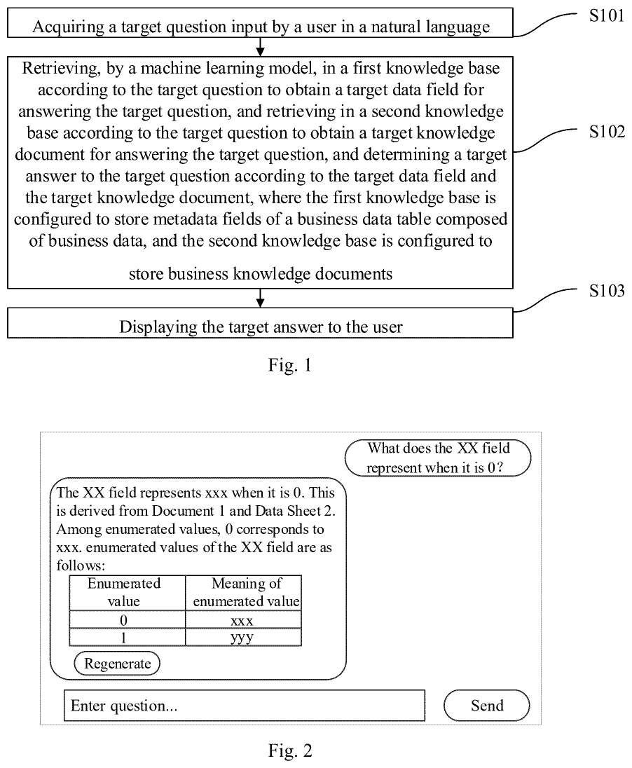

FIG. 1 is a flow chart of a knowledge question and answer method according to an exemplary embodiment of the present disclosure. Referring to FIG. 1, the method may include the following steps.

S101: acquiring a target question input by a user in a natural language.

Exemplarily, taking a business platform as an example, a search box may be displayed on a platform page, and when the user performs an input operation in the search box, the target question input by the user in the natural language is acquired. Alternatively, an intelligent object may be displayed on the platform page, and an intelligent object page as shown in FIG. 2 is displayed on the platform page by clicking on the intelligent object. When the user performs an input operation on the intelligent object page, the target question input by the user in the natural language is acquired.

S102: retrieving, by a machine learning model, in a first knowledge base according to the target question to obtain a target data field for answering the target question, and retrieving in a second knowledge base according to the target question to obtain a target knowledge document for answering the target question, and determining a target answer to the target question according to the target data field and the target knowledge document, where the first knowledge base is configured to store metadata fields of a business data table composed of business data, and the second knowledge base is configured to store business knowledge documents.

Exemplarily, after the target question input by the user is acquired, the target question may be input into a pre-trained machine learning model, and the machine learning model retrieves, based on the target question, a related metadata field in the first knowledge base and a related knowledge document in the second knowledge base, and then obtains the answer to the question based on the metadata field and the knowledge document.

In the embodiment, the business knowledge documents stored in the knowledge base may be determined according to actual situations. For example, a corresponding document knowledge base and a corresponding data knowledge base may be constructed based on different fields, such as an e-commerce field, etc., where the document knowledge base includes unstructured document knowledge, and the data knowledge base includes structured data knowledge, which is not limited in the embodiments of the present disclosure.

S103: displaying the target answer to the user.

In the embodiment, the display manner of displaying the target answer to the user may be set according to actual situations, which is not limited in the embodiments of the present disclosure.

With the above technical solutions, the machine learning model may first retrieve in the first knowledge base and the second knowledge base respectively according to the target question input by the user to obtain the target data field and the target knowledge document, and then the machine learning model determines the target answer to the target question according to the target data field and the target knowledge document and displays the target answer to the user. Thus, the machine learning model can understand the question input by the user, and automatically search and organize the data field and the knowledge document based on the question input by the user, so as to directly display the answer to the question to the user. There is no need for the user to retrieve the data field and the knowledge document separately, which can not only improve the accuracy and search efficiency of knowledge retrieval by the user, but also directly obtain the answer to the question, thereby improving the efficiency of the user obtaining the answer to the question.

To facilitate understanding of the solution, possible implementations of the present disclosure will be described below.

In a possible implementation, the determining the target answer to the target question according to the target data field and the target knowledge document includes: determining content relevance between the target question and the target data field and content relevance between the target question and the target knowledge document respectively; determining a preset number of pieces of knowledge data from the target data field and the target knowledge document according to the content relevance, where content relevance corresponding to the preset number of pieces of knowledge data is greater than content relevance corresponding to knowledge data other than the preset number of pieces of knowledge data in the target data field and the target knowledge document; and determining the target answer to the target question according to the preset number of pieces of knowledge data.

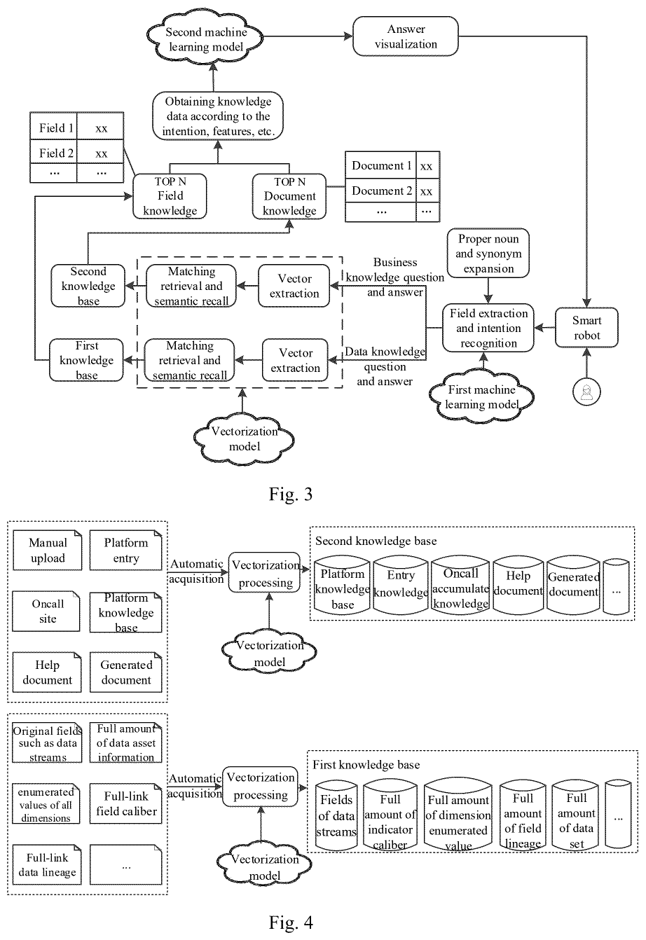

Exemplarily, as shown in FIG. 3, when a plurality of target data fields and a plurality of target knowledge documents exist, for each target knowledge document, the content relevance between the target question and the target knowledge document is determined, and for each target data field, the content relevance between the target question and the target data field is determined. Then, the plurality of target data fields and the plurality of target knowledge documents are sorted according to the content relevance, and knowledge data with greater content relevance is selected, where the target data fields and the target knowledge documents may be sorted and selected separately, or the target data fields and the target knowledge documents may be sorted and selected in combination. Then the target answer to the target question is determined according to the knowledge data with greater content relevance.

In the embodiment, a preset number of pieces of knowledge data with greater content relevance may be selected, or knowledge data with relevance greater than a preset threshold may be selected, where the preset number and the preset threshold may be determined according to actual situations, which is not limited in the embodiments of the present disclosure.

Exemplarily, for example, the preset number may be set to 10, and the top 10 pieces of knowledge data with greater content relevance are selected from the plurality of target data fields and the plurality of target knowledge documents. For another example, the preset threshold may be set to 80%, and knowledge data with content relevance greater than 80% is selected from the plurality of target data fields and the plurality of target knowledge documents. Therefore, knowledge data with higher relevance to the target question may be further filtered out, thereby improving the accuracy of the target answer.

In a possible implementation, the determining the content relevance between the target question and the target data field and the content relevance between the target question and the target knowledge document respectively includes: inputting the target question, the target data field and the target knowledge document into a relevance model to obtain the content relevance between the target question and the target data field and the content relevance between the target question and the target knowledge document respectively, where the relevance model is configured to output, according to a question and a data field that are input, content relevance between the question and the data field, and output, according to a question and a knowledge document that are input, content relevance between the question and the knowledge document.

Exemplarily, content relevance between the target question and each target knowledge document or the target data field may be determined based on the pre-trained relevance model. The relevance model may be a relevance model in the related art, or a relevance model obtained by improving the relevance model in the related art. In addition, the relevance model may be a separate model or a sub-model in the machine learning model, which is not limited in the embodiments of the present disclosure.

In a possible implementation, the knowledge question and answer method further includes: performing intention recognition on the target question to obtain an intention recognition result. The determining the target answer to the target question according to the target data field and the target knowledge document includes: determining a target template from a preset prompt template according to the intention recognition result; generating a target prompt according to the target data field, the target knowledge document, the target question and the target template, where the target prompt is used to instruct the machine learning model to determine the target answer to the target question according to the target data field and the target knowledge document; and inputting the target prompt into the machine learning model to obtain the target answer to the target question.

Exemplarily, intention recognition is performed on the target question to obtain the intention recognition result, and it is determined whether the target question is a question for the data field, a question for the knowledge document, or a mixed question for the data field and the knowledge document, and then the corresponding prompt template is determined according to the intention recognition result. In the embodiment, the prompt template may be set according to actual situations, which is not limited in the embodiments of the present disclosure. For example, the prompt template corresponding to the mixed question may be set to: please generate a structured answer to the corresponding question extracted from the knowledge document corresponding to the document identification and the data table corresponding to the data field based on “query question: XXXX, document identification: XXXX, data field: XXXX”.

In the embodiment, the prompt template is preset, so that after the document identification and the data field of the target knowledge document and the query question and are obtained, the query question, the data field and the document identification may be directly filled into corresponding positions of the prompt template, so that the target prompt text may be quickly generated, thereby the generation speed of the structured answer may be improved, and the user experience may be improved.

In the embodiment, as shown in FIG. 2, the target answer may be displayed on the display page, and a re-generation control “Regenerate” is displayed beside the target answer. By clicking on “Regenerate”, the knowledge document and the data field are retrieved again according to the target question, and the target answer is generated again.

In the above manner, the interactive control to regenerate the answer corresponding to the target question may be displayed for the user to trigger while the target answer is displayed to the user, so that the answer may be regenerated according to the actual needs of the user and the target answer, thereby further improving the accuracy of the target answer.

In a possible implementation, the knowledge question and answer method further includes: performing intention recognition on the target question to obtain an intention recognition result. The determining the target answer to the target question according to the target data field and the target knowledge document includes: determining knowledge data for answering the target question from the target data field and the target knowledge document according to the intention recognition result; and determining the target answer to the target question according to the knowledge data.

Exemplarily, intention recognition is performed on the target question to obtain the intention recognition result, and it is determined whether the target question is a question for the data field, a question for the knowledge document, or a mixed question for the data field and the knowledge document. Then knowledge data for answering the target question is determined from the target data field and the target knowledge document based on different intention recognition results, and then the target answer to the target question is determined.

Exemplarily, weight adjustment or re-sorting may be performed on the target data field and the target knowledge document according to the intention recognition result. For example, when the question is for the data field, the target data field is preferentially selected, or more target data fields are selected than the target knowledge document.

Exemplarily, for example, for a question of “what does the xx field mean”, the xx field may be explained in combination with the knowledge document, and different meanings of the field represented under different enumerated values may be explained, that is, the target answer is determined in combination with the data field and the knowledge document. The specific determination may be made according to actual business scenarios, which is not limited in the embodiments of the present disclosure.

It should be noted that the display style of the target answer may also be determined according to different intention recognition results. For example, for a question for the data field, different meanings represented under different enumerated values may be displayed in the form of a list, and for a question for the knowledge document, it may be displayed in the form of a natural language.

In a possible implementation, the retrieving, by the machine learning model, in the first knowledge base according to the target question to obtain the target data field for answering the target question includes: extracting a key field from the target question by the machine learning model; performing semantic recall in the first knowledge base according to at least the key field to obtain a first data field, where the semantic recall is used to query, in the first knowledge base, a data field with semantic similarity greater than a preset threshold to the key field; and performing matching retrieval in the first knowledge base according to at least the key field to obtain a second data field, where the matching retrieval is used to query, in the first knowledge base, a data field equal to the key field; accordingly, the target data field includes the first data field and the second data field.

Exemplarily, the semantic recall is used to query a data field in the first knowledge base that is semantically similar to the key field. For example, the semantic similarity may be calculated by cosine similarity, and then the first data field with similarity greater than the preset threshold is obtained. The matching retrieval is used to retrieve a second data field in the first knowledge base equal to the key field, that is, with similarity equal to 100%. Thus the target data field is obtained, where the preset threshold may be determined according to the requirement, which is not limited in the embodiments of the present disclosure.

Exemplarily, a data table where the similar field or the key field is located may also be obtained, which is not limited in the embodiments of the present disclosure.

Exemplarily, the metadata in the first knowledge base may be stored in the form of an embedding vector. Therefore, as shown in FIG. 3, the key field may be input into the pre-trained vectorization model to obtain the corresponding target embedding vector. After the target embedding vector is obtained, the semantic recall or the matching retrieval is performed in the first knowledge base based on the target embedding vector.

It should be noted that a correspondence between the data field and the embedding vector may also be pre-stored in the first knowledge base, so that after the embedding vector corresponding to the key field is determined, the corresponding data field is determined based on the correspondence.

In the above manner, the field search may be performed in the first knowledge base based on the two manners of the semantic recall and the matching retrieval. Since the semantic recall is used to query, in the first knowledge base, the data field with the semantic similarity greater than the preset threshold between the metadata and the key field, the data field that is semantically similar to the key field may be found, thereby increasing the recall breadth. The matching retrieval is used to retrieve the data field in the first knowledge base equal to the key field, so that the data field where the key field is located may be quickly located, thereby implementing more accurate and efficient data retrieval.

In a possible implementation, the retrieving in the second knowledge base according to the target question to obtain the target knowledge document for answering the target question includes: extracting a key field from the target question by the machine learning model; performing semantic recall in the second knowledge base according to at least the key field to obtain a first knowledge document, where the semantic recall is used to query, in the second knowledge base, a knowledge document that includes a similar field, and semantic similarity between the similar field and the key field is greater than a preset threshold; and performing matching retrieval in the second knowledge base according to at least the key field to obtain a second knowledge document, where the matching retrieval is used to query, in the second knowledge base, a knowledge document that includes the key field; accordingly, the target knowledge document includes the first knowledge document and the second knowledge document.

Exemplarily, the semantic recall is used to query, in the second knowledge base, the knowledge document that includes the similar field. For example, the field similarity may be calculated by cosine similarity, and then the knowledge document where the similar field with the similarity greater than the preset threshold is located is taken as the first knowledge document. The matching retrieval is used to retrieve the knowledge document in the knowledge base that includes the key field. For example, the number of the key field, in each knowledge document including the key field, may be counted, and then the knowledge document with the largest number is selected as the second knowledge document. Alternatively, scores may be preset for different intervals of the number of the same field, and then the corresponding score is determined according to the number of the key field, and then the knowledge document with the highest score is selected as the second knowledge document. The specific determination may be made according to requirements, which is not limited in the embodiments of the present disclosure.

Exemplarily, the knowledge fragment in the second knowledge base may be stored in the form of an embedding vector. Therefore, as shown in FIG. 3, the key field may be input into the pre-trained vectorization model to obtain the corresponding target embedding vector. After the target embedding vector is obtained, the semantic recall or the matching retrieval is performed in the knowledge base based on the target embedding vector.

It should be noted that the correspondence between the document identification and the knowledge fragment vector may also be pre-stored in the second knowledge base, so that after the knowledge fragment vector corresponding to the key field is determined, the corresponding document identification is determined based on the correspondence, and then the target knowledge document corresponding to the document identification is acquired.

It should be understood that the above description is only illustrative and does not constitute a limitation on the solution. In a possible implementation, the machine learning model that extracts the key field of the target question and the machine learning model that performs the vectorization processing on the key field may be the same machine learning model.

In the above manner, the document search may be performed in the second knowledge base based on the two manners of the semantic recall and the matching retrieval. Since the semantic recall is used to query, in the second knowledge base, the similar field with the semantic similarity greater than the preset threshold between the similar field and the key field, the knowledge document where the field that is semantically similar to the key field is located may be found, thereby increasing the recall breadth. The matching retrieval can quickly locate the knowledge document where the key field is located, thereby implementing more accurate and efficient data retrieval.

In a possible implementation, the business knowledge documents in the second knowledge base are stored by: acquiring a plurality of business knowledge documents through different channels; performing splitting processing on each of the business knowledge documents to obtain a business knowledge fragment; performing vectorization processing on the business knowledge fragment to obtain a knowledge fragment vector; and storing the knowledge fragment vector into the second knowledge base.

Exemplarily, as shown in FIG. 4, documents uploaded by users in the business platform, entry contents defined by the platform, a platform knowledge base generated based on documents in the platform, help documents for external use of the platform, oncall sites, that is, question and answer contents manually maintained, and documents automatically generated based on a plurality of documents, etc. may be acquired, which may be specifically determined according to actual business scenarios, and is not limited in the embodiments of the present disclosure. Further, the acquired business knowledge documents may be split to obtain the business knowledge fragment.

In the embodiment, the business knowledge document may be stored in the knowledge base in the form of a natural language, or may be stored in the knowledge base in the form of an embedding vector, which is not limited in the embodiments of the present disclosure. If the business knowledge document is stored in the form of a natural language, it is stored in the knowledge base after the business knowledge fragment is obtained. If the business knowledge document is stored in the form of an embedding vector, vectorization processing may be performed on the business knowledge fragment by the vectorization model, and the obtained knowledge fragment vector is stored. Thus, the second knowledge base is obtained.

Accordingly, in the embodiment, the metadata of the data table stored in the first knowledge base may be determined according to actual situations, which is not limited in the embodiments of the present disclosure. Exemplarily, in order to perform data search from different dimensions, as shown in FIG. 4, the metadata may include at least one of an indicator caliber, a data lineage, a data indicator, a data dimension, an enumerated value of the data dimension, a data label of the data table, etc. in the data table, which may be specifically determined according to actual business scenarios, and is not limited in the embodiments of the present disclosure.

In the embodiment, the indicator caliber, the data lineage, the data indicator, the data dimension, the enumerated value and the data label may be determined according to actual situations, which is not limited in the embodiments of the present disclosure. Exemplarily, in the e-commerce field, the data indicator may be sales volume, visits or clicks, etc. The data dimension may be a product category, a sales region or a sales time, etc. The enumerated value may be a category of products, such as electronic products, beauty products or home apparel, etc. The data label may be a category of the data table, such as a data table of electronic products or a data table of beauty products. The indicator caliber may be a specification of a statistical method, a calculation logic and a business definition of the data indicator, and the data lineage may be an association relationship between different data.

In the embodiment, the metadata may be stored in the first knowledge base in the form of a natural language, or may be stored in the first knowledge base in the form of an embedding vector, which is not limited in the embodiments of the present disclosure.

As shown in FIG. 4, when the metadata is stored in the first knowledge base in the form of a natural language, fields contained in respective data tables and original fields such as respective data streams may be acquired in the business scenario, and then a correspondence between the fields contained in the respective data tables and the original fields such as the respective data streams is established. When the metadata is stored in the first knowledge base in the form of an embedding vector, the fields contained in the respective data tables and the original fields such as the respective data streams may be acquired in the business scenario, and then the fields contained in the data table are extracted and vectorized to obtain the corresponding embedding vector, and then the correspondence between the original fields such as the respective data streams and the respective embedding vectors is established. Thus, the first knowledge base is obtained.

In a possible implementation, as shown in FIG. 3, the target data field for answering the target question may be obtained by retrieving in the first knowledge base according to the target question by a first machine learning model, and the target knowledge document for answering the target question may be obtained by retrieving in the second knowledge base according to the target question by the first machine learning model, and then the target answer to the target question is determined by a second machine learning model based on the target knowledge document and the target data field.

In the embodiment, the first machine learning model that retrieves in the first knowledge base and the first machine learning model that retrieves in the second knowledge base may be the same model or different models. Accordingly, the first machine learning model and the second machine learning model may be different models, or may be different sub-models in the same machine learning model, which is not limited in the present disclosure. In addition, the vectorization model disclosed in the embodiments of the present disclosure may be another model different from the machine learning model, or may be a sub-model integrated in the machine learning model. For example, the vectorization model and the first machine learning model as shown in FIG. 4 are different sub-models of the same machine learning model, or the same machine learning model integrates the vectorization model as shown in FIG. 3 and FIG. 4, the first machine learning model and the second machine learning model, which is not limited in the embodiments of the present disclosure.

The first machine learning model may be a machine learning model in the related art, or a machine learning model obtained by improving a machine learning model in the related art. The embodiments of the present disclosure are not limited in this respect. Exemplarily, the first machine learning model may be a Transformer model in the related art. Therefore, the Transformer model may be trained by constructing training samples, so that the Transformer model can accurately extract the knowledge document and the field data based on the target question.

Exemplarily, a sample statement marked with a label and used to query the knowledge document or the field data may be acquired, where the label is used to indicate a key field of the sample statement. The sample statement is input into the Transformer model to obtain a predicted key field, and a loss function value between an actual key field and the predicted key field is calculated, and a parameter value of the Transformer model is adjusted based on the loss function value until the Transformer model converges.

The second machine learning model may be a machine learning model in the related art, or a machine learning model obtained by improving a machine learning model in the related art. The embodiments of the present disclosure are not limited in this respect. Exemplarily, the second machine learning model may be a large language model (LLM) in the related art. Therefore, the LLM model may be trained by constructing training samples, so that the LLM model can output a structured answer to the question according to the input prompt.

Exemplarily, a sample prompt marked with a label may be acquired, where the label is used to indicate an actual structured answer to the question corresponding to the sample prompt. The sample prompt is input into the LLM model to obtain a predicted structured answer to the question, and a loss function value between the actual structured answer to the question and the predicted structured answer to the question is calculated, and a parameter value of the LLM model is adjusted based on the loss function value until the LLM model converges.

In the embodiment, as shown in FIG. 3, intention recognition and key field extraction may be performed on the target question based on the first machine learning model, and keyword expansion may also be performed based on the first machine learning model, which is not limited in the embodiments of the present disclosure.

In a possible implementation, the method further includes: determining an expansion word with the same semantics as the key field. The performing the semantic recall in the second knowledge base according to at least the key field includes: performing the semantic recall in the second knowledge base according to the key field and the expansion word, where the semantic recall is used to query, in the second knowledge base, a knowledge document that includes a first similar field, and semantic similarity between the first similar field and the key field or the expansion word is greater than a preset threshold. The performing the matching retrieval in the second knowledge base according to at least the key field includes: performing the matching retrieval in the second knowledge base according to the key field and the expansion word, where the matching retrieval is used to retrieve a knowledge document in the knowledge base that includes the key field or the expansion word.

Exemplarily, the key field is “consume”, and the expansion word determined in the preset lexicon with the same semantics as “consume” is “cost”. Thus, the matching retrieval may be performed in the second knowledge base based on “consume” and “cost” respectively. If the knowledge document A is matched in the second knowledge base based on “consume”, and the knowledge document B is matched in the second knowledge base based on “cost”, the target knowledge document is obtained.

Exemplarily, the key field is “consume”, and the expansion word determined in the preset lexicon with the same semantics as “consume” is “cost”. Thus, the semantic recall may be performed in the second knowledge base based on the semantics of “consume” and “cost” respectively. If the knowledge document C is recalled in the second knowledge base according to the semantics of “consume”, and the knowledge document D is recalled in the second knowledge base according to the semantics of “cost”, the target knowledge document is obtained.

Exemplarily, the key field is “consume”, and the expansion word determined in the preset lexicon with the same semantics as “consume” is “cost”. Thus, the matching retrieval and the semantic recall may be performed in the second knowledge base according to “consume” and “cost” respectively. If the knowledge document A is matched in the knowledge base according to “consume”, the knowledge document B is matched in the second knowledge base according to “cost”, the knowledge document C is recalled in the second knowledge base according to the semantics of “consume”, and the knowledge document D is recalled in the second knowledge base according to the semantics of “cost”, the target knowledge document is obtained.

In the above manner, the expansion word with the same semantics as the key field may be acquired, so that the knowledge document search is performed in the second knowledge base according to the key field and the expansion word. Since the expansion word has the same semantics as the key field, the relevance and accuracy of the search result may be improved.

The implementation of the solution in this embodiment may refer to the related description of performing the semantic recall and the matching retrieval in the second knowledge base based on the key field, which will not be repeated here. The target knowledge document may refer to the entire knowledge document or the knowledge document fragment, which is not limited in the embodiments of the present disclosure.

It should be understood that the manner of performing the search in the second knowledge base according to the key field and the expansion word in this embodiment is only illustrative and does not constitute a limitation on the solution. When the knowledge fragment in the second knowledge base is stored in the form of an embedding vector, in a possible implementation, after the embedding vectors corresponding to the key field and the expansion word are determined, the matching retrieval may be performed in the second knowledge base according to the embedding vectors corresponding to the key field and the expansion word. And/or, the semantic recall is performed in the second knowledge base according to the embedding vectors corresponding to the key field and the expansion word.

Correspondingly, the data field search may also be performed in the first knowledge base based on the key field and the expansion word, and the specific process may refer to the search process of the above knowledge document search, which will not be repeated here in the present disclosure. Since the expansion word has the same semantics as the key field, the relevance and accuracy of the search result may be improved.

To facilitate understanding of the knowledge question and answer method of the present disclosure, a possible implementation of the solution is described below.

As shown in FIG. 2, an intelligent object is displayed on a platform page, and an intelligent object page is displayed on the platform page by clicking on the intelligent object. After the user inputs the target question “What does the XX field represent when it is 0?” in the natural language on the intelligent object page, the target question is input into the first machine learning model at the backend of the platform, and the first machine learning model performs intention recognition and extracts the key field from the target question to obtain the key fields “XX” and “0”. Then, proper noun and/or synonym expansion is performed in the preset lexicon based on the semantics of “XX” and “0” to obtain the expansion word “XXX”. After the expansion word “XXX” is obtained, vectorization processing is performed by the first machine learning model based on “XX”, “0” and “XXX”, and then matching retrieval and semantic recall are performed in a knowledge base to obtain the target knowledge document and the target data field. Then, the relevance model is used to determine the relevance between the target question and the target knowledge document and the relevance between the target question and the target data field respectively, the knowledge data with higher relevance is determined from them, and the document identification corresponding to the knowledge document, the data field and the target question are filled into corresponding positions of the prompt template to obtain the target prompt text. The target prompt text is input into the second machine learning model to obtain the structured answer to the corresponding question extracted from the knowledge document corresponding to the document identification and the data table where the data field is located. For example, the XX field may be explained, and the meaning represented by the XX field when it is 0 may be explained, and the meanings represented by the XX field at other values may also be listed, etc.

With the above method, the machine learning model is used to recognize and understand the question input by the user, and extract the key field from the question, and retrieve related data knowledge in the business knowledge base and the data knowledge base based on the key field, thereby the accuracy of recalling the document related to the user's question may be improved. Then the weights of the recalled knowledge data are adjusted according to different user intentions, thereby the accuracy of recalling the user's related question may be improved. Then the adjusted data knowledge is handed over to the machine learning model for summary answering, so that the user directly obtains the answer to the question without having to search for the business document and the data table by the user himself/herself. This can not only improve the accuracy and search efficiency of the user retrieving the knowledge document and the data field, but also directly obtain the answer to the question, thereby improving the efficiency of the user understanding the knowledge.

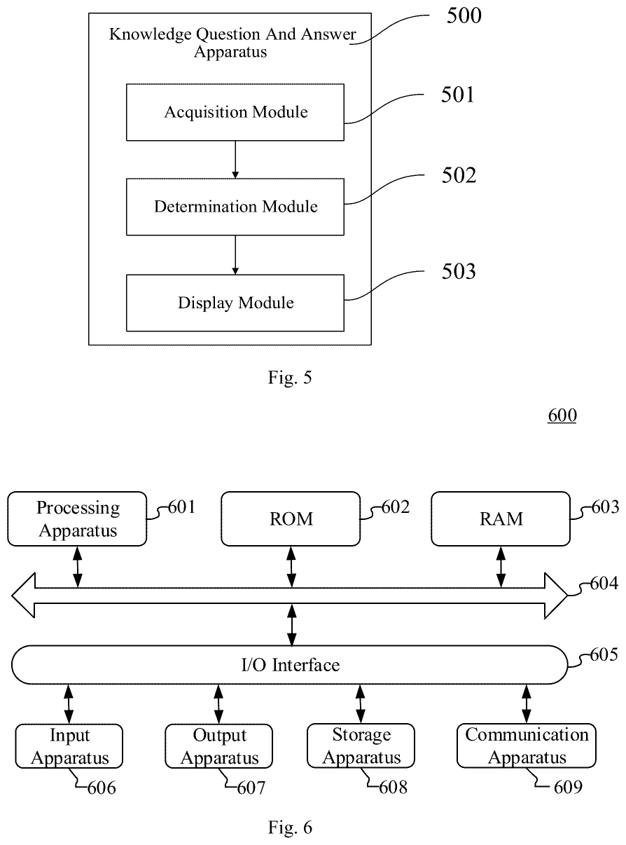

Based on the same concept, the embodiments of the present disclosure further provide a knowledge question and answer apparatus. As shown in FIG. 5, the knowledge question and answer apparatus 500 may include:
an acquisition module 501, configured to acquire a target question input by a user in a natural language;
a determination module 502, configured to retrieve, by a machine learning model, in a first knowledge base according to the target question to obtain a target data field for answering the target question, and retrieve in a second knowledge base according to the target question to obtain a target knowledge document for answering the target question, and determine a target answer to the target question according to the target data field and the target knowledge document, where the first knowledge base is configured to store metadata fields of a business data table composed of business data, and the second knowledge base is configured to store business knowledge documents; and
a display module 503, configured to display the target answer to the user.

With the above apparatus, the field search may be performed in the first knowledge base based on the two manners of the semantic recall and the matching retrieval. Since the semantic recall is used to query, in the first knowledge base, the data field with the semantic similarity greater than the preset threshold between the metadata and the key field, the data field that is semantically similar to the key field may be found, thereby increasing the recall breadth. The matching retrieval is used to retrieve the data field in the first knowledge base equal to the key field, so that the data field where the key field is located may be quickly located, thereby implementing more accurate and efficient data retrieval.

In a possible implementation, the determination module 502 includes:
a first determination sub-module, configured to determine content relevance between the target question and the target data field and content relevance between the target question and the target knowledge document respectively;
a second determination sub-module, configured to determine a preset number of pieces of knowledge data from the target data field and the target knowledge document according to the content relevance, where content relevance corresponding to the preset number of pieces of knowledge data is greater than content relevance corresponding to knowledge data other than the preset number of pieces of knowledge data in the target data field and the target knowledge document; and
a third determination sub-module, configured to determine the target answer to the target question according to the preset number of pieces of knowledge data.

In a possible implementation, the first determination sub-module is configured to:
input the target question, the target data field and the target knowledge document into a relevance model to obtain the content relevance between the target question and the target data field and the content relevance between the target question and the target knowledge document respectively, where the relevance model is configured to output, according to a question and a data field that are input, content relevance between the question and the data field, and output, according to a question and a knowledge document that are input, content relevance between the question and the knowledge document.

In a possible implementation, the knowledge question and answer apparatus 500 further includes:
a first recognition module, configured to perform intention recognition on the target question to obtain an intention recognition result.

The determination module 502 is configured to:
determine knowledge data for answering the target question from the target data field and the target knowledge document according to the intention recognition result; and
determine the target answer to the target question according to the knowledge data.

In a possible implementation, the knowledge question and answer apparatus 500 further includes:
a second recognition module, configured to perform intention recognition on the target question to obtain an intention recognition result.

The determination module 502 is configured to:
determine a target template from a preset prompt template according to the intention recognition result;
generate a target prompt according to the target data field, the target knowledge document, the target question and the target template, where the target prompt is used to instruct the machine learning model to determine the target answer to the target question according to the target data field and the target knowledge document; and
input the target prompt into the machine learning model to obtain the target answer to the target question.

In a possible implementation, the determination module 502 is configured to:
extract a key field from the target question by the machine learning model;
perform semantic recall in the first knowledge base according to at least the key field to obtain a first data field, where the semantic recall is used to query, in the first knowledge base, a data field with semantic similarity greater than a preset threshold to the key field; and
perform matching retrieval in the first knowledge base according to at least the key field to obtain a second data field, where the matching retrieval is used to query, in the first knowledge base, a data field equal to the key field;
accordingly, the target data field includes the first data field and the second data field.

In a possible implementation, the determination module 502 is configured to:
extract a key field from the target question by the machine learning model;
perform semantic recall in the second knowledge base according to at least the key field to obtain a first knowledge document, where the semantic recall is used to query, in the second knowledge base, a knowledge document that includes a similar field, and semantic similarity between the similar field and the key field is greater than a preset threshold; and
perform matching retrieval in the second knowledge base according to at least the key field to obtain a second knowledge document, where the matching retrieval is used to query, in the second knowledge base, a knowledge document that includes the key field;
accordingly, the target knowledge document includes the first knowledge document and the second knowledge document.

Optionally, the business knowledge documents in the second knowledge base are stored by:
acquiring a plurality of business knowledge documents through different channels;
performing splitting processing on each of the business knowledge documents to obtain a business knowledge fragment;
performing vectorization processing on the business knowledge fragment to obtain a knowledge fragment vector; and
storing the knowledge fragment vector into the second knowledge base.

Based on the same concept, an embodiment of the present disclosure further provides a computer-readable medium storing thereon a computer program which, when executed by a processing apparatus, performs the steps of any one of the above knowledge question and answer methods.

Based on the same concept, an embodiment of the present disclosure further provides an electronic device, including:
a storage apparatus storing thereon a computer program; and
a processing apparatus, configured to execute the computer program in the storage apparatus to implement the steps of any one of the above knowledge question and answer methods.

Based on the same concept, the embodiments of the present disclosure further provide a computer program product, including a computer program which, when executed by a processor, performs the steps of any one of the above knowledge question and answer methods.

Reference is made to FIG. 6 below, which illustrates a structural diagram of an electronic device 600 suitable for implementing the embodiments of the present disclosure. The terminal device in the embodiments of the present disclosure may include, but is not limited to, a mobile terminal such as a mobile phone, a laptop, a digital broadcast receiver, a personal digital assistant (PDA), a tablet computer (PAD), a portable multimedia player (PMP), a vehicle-mounted terminal (such as a vehicle-mounted navigation terminal), and a fixed terminal such as a digital TV and a desktop computer. The electronic device shown in FIG. 6 is only an example and should not impose any limitation on the functions and usage scope of the embodiments of the present disclosure.

As shown in FIG. 6, the electronic device 600 may include a processing apparatus 601 (such as a central processing unit, a graphics processor, etc.), which may perform various appropriate actions and processing according to a program stored in a read-only memory (ROM) 602 or a program loaded from a storage apparatus 608 into a random access memory (RAM) 603. Various programs and data required for the operation of the electronic device 600 are also stored in the RAM 603. The processing apparatus 601, the ROM 602 and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, a gyroscope, etc.; an output apparatus 607 including, for example, a liquid crystal display (LCD), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. Although FIG. 6 shows the electronic device 600 having various apparatuses, it should be understood that not all of the illustrated apparatuses are necessarily implemented or provided. Alternatively, more or fewer apparatuses may be implemented or provided.

Particularly, according to the embodiments of the present disclosure, the processes described above with reference to the flowcharts may be implemented as a computer software program. For example, an embodiment of the present disclosure includes a computer program product, which includes a computer program carried on a non-transitory computer-readable medium, and the computer program includes program codes for executing the methods illustrated in the flowcharts. In such an embodiment, the computer program may be downloaded and installed from the network through the communication apparatus 609, or may be installed from the storage apparatus 608, or may be installed from the ROM 602. When the computer program is executed by the processing apparatus 601, the above functions defined in the method of the embodiments of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus or device, or any combination of the above. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium may be any tangible medium that contains or stores a program that can be used by or in combination with an instruction execution system, apparatus or device. In the present disclosure, the computer-readable signal medium may include a data signal propagated in a baseband or as a part of a carrier, in which computer-readable program codes are carried. This propagated data signal may take many forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit a program for use by or in combination with an instruction execution system, apparatus or device. The program codes contained on the computer-readable medium may be transmitted by any suitable medium, including but not limited to: a wire, an optical cable, RF (Radio Frequency), etc., or any suitable combination of the above.

In some implementations, any currently known or future developed network protocol such as HTTP (HyperText Transfer Protocol) may be used for communication, and may be interconnected with digital data communication (e.g., communication network) in any form or medium. Examples of communication networks include local area networks (“LAN”), wide area networks (“WAN”), the Internet, and end-to-end networks (e.g., ad hoc end-to-end networks), as well as any currently known or future developed network.

The above computer-readable medium may be included in the above electronic device, or may exist alone without being assembled into the electronic device.

The above computer-readable medium carries one or more programs which, when executed by the electronic device, cause the electronic device to: acquire a target question input by a user in a natural language; retrieve, by a machine learning model, in a first knowledge base according to the target question to obtain a target data field for answering the target question, and retrieve in a second knowledge base according to the target question to obtain a target knowledge document for answering the target question, and determine a target answer to the target question according to the target data field and the target knowledge document, where the first knowledge base is configured to store metadata fields of a business data table composed of business data, and the second knowledge base is configured to store business knowledge documents; and display the target answer to the user.

The computer program codes for performing the operations of the present disclosure may be written in one or more programming languages or a combination thereof. The above programming languages include but are not limited to object-oriented programming languages such as Java, Smalltalk, C++, and also include conventional procedural programming languages such as C or similar programming languages. The program codes may be executed entirely on the user's computer, partly on the user's computer, as a stand-alone software package, partly on the user's computer and partly on a remote computer, or entirely on the remote computer or server. In the case of involving the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings show possible architecture, functions and operations of the system, method and computer program product according to various embodiments of the present disclosure. In this regard, each block in the flowcharts or block diagrams may represent a module, a program segment, or a part of codes, and the module, the program segment, or the part of codes contains one or more executable instructions for implementing specified logical functions. It should also be noted that, in some alternative implementations, the functions marked in the blocks may also occur in a different order than those marked in the drawings. For example, two blocks shown in succession may, in fact, be executed substantially in parallel, or they may sometimes be executed in a reverse order, depending on the functions involved. It should also be noted that, each block in the block diagrams and/or flowcharts, and a combination of blocks in the block diagrams and/or flowcharts, may be implemented by a special-purpose hardware-based system that performs specified functions or operations, or may be implemented by a combination of special-purpose hardware and computer instructions.

The modules involved in the embodiments described in the present disclosure may be implemented by software or hardware. Among them, the name of the module does not constitute a limitation on the module itself under certain circumstances.

The functions described herein above may be performed, at least partially, by one or more hardware logic components. For example, without limitation, exemplary types of hardware logic components that may be used include: a field programmable gate array (FPGA), an application specific integrated circuit (ASIC), an application specific standard product (ASSP), a system on a chip (SOC), a complex programmable logical device (CPLD), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The above description is only preferred embodiments of the present disclosure and an illustration of the applied technical principles. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosed concept, for example, a technical solution formed by replacing the above features with technical features with similar functions disclosed in the present disclosure (but not limited to).

In addition, while operations are depicted in a particular order, this should not be understood as requiring that such operations are performed in the particular order shown or in a sequential order. Under certain circumstances, multitasking and parallel processing may be advantageous. Likewise, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely example forms of implementing the claims. Regarding the apparatus in the above embodiments, the specific manner in which the respective modules perform the operations has been described in detail in the embodiments related to the method, and will not be described in detail here.

1. A knowledge question and answer method, comprising:
acquiring a target question input by a user in a natural language;
retrieving, by a machine learning model, in a first knowledge base according to the target question to obtain a target data field for answering the target question, and retrieving in a second knowledge base according to the target question to obtain a target knowledge document for answering the target question, and determining a target answer to the target question according to the target data field and the target knowledge document, wherein the first knowledge base is configured to store metadata fields of a business data table composed of business data, and the second knowledge base is configured to store business knowledge documents; and
displaying the target answer to the user.

2. The knowledge question and answer method according to claim 1, wherein the determining the target answer to the target question according to the target data field and the target knowledge document comprises:
determining content relevance between the target question and the target data field and content relevance between the target question and the target knowledge document respectively;
determining a preset number of pieces of knowledge data from the target data field and the target knowledge document according to the content relevance between the target question and the target data field and content relevance between the target question and the target knowledge document, wherein content relevance corresponding to the preset number of pieces of knowledge data is greater than content relevance corresponding to knowledge data other than the preset number of pieces of knowledge data in the target data field and the target knowledge document; and
determining the target answer to the target question according to the preset number of pieces of knowledge data.

3. The knowledge question and answer method according to claim 2, wherein the determining the content relevance between the target question and the target data field and the content relevance between the target question and the target knowledge document respectively comprises:
inputting the target question, the target data field and the target knowledge document into a relevance model to obtain the content relevance between the target question and the target data field and the content relevance between the target question and the target knowledge document respectively, wherein the relevance model is configured to output, according to a question and a data field that are input, content relevance between the question and the data field, and output, according to a question and a knowledge document that are input, content relevance between the question and the knowledge document.

4. The knowledge question and answer method according to claim 1, further comprising:
performing intention recognition on the target question to obtain an intention recognition result,
wherein the determining the target answer to the target question according to the target data field and the target knowledge document comprises:
determining knowledge data for answering the target question from the target data field and the target knowledge document according to the intention recognition result; and
determining the target answer to the target question according to the knowledge data.

5. The knowledge question and answer method according to claim 1, further comprising:
performing intention recognition on the target question to obtain an intention recognition result;
wherein the determining the target answer to the target question according to the target data field and the target knowledge document comprises:
determining a target template from a preset prompt template according to the intention recognition result;
generating a target prompt according to the target data field, the target knowledge document, the target question and the target template, wherein the target prompt is used to instruct the machine learning model to determine the target answer to the target question according to the target data field and the target knowledge document; and
inputting the target prompt into the machine learning model to obtain the target answer to the target question.

6. The knowledge question and answer method according to claim 1, wherein the retrieving, by the machine learning model, in the first knowledge base according to the target question to obtain the target data field for answering the target question comprises:
extracting a key field from the target question by the machine learning model;
performing semantic recall in the first knowledge base according to at least the key field to obtain a first data field, wherein the semantic recall is used to query, in the first knowledge base, a data field with semantic similarity greater than a preset threshold to the key field; and
performing matching retrieval in the first knowledge base according to at least the key field to obtain a second data field, wherein the matching retrieval is used to query, in the first knowledge base, a data field equal to the key field;
wherein the target data field comprises the first data field and the second data field.

7. The knowledge question and answer method according to claim 1, wherein the retrieving in the second knowledge base according to the target question to obtain the target knowledge document for answering the target question comprises:
extracting a key field from the target question by the machine learning model;
performing semantic recall in the second knowledge base according to at least the key field to obtain a first knowledge document, wherein the semantic recall is used to query, in the second knowledge base, a knowledge document that comprises a similar field, and semantic similarity between the similar field and the key field is greater than a preset threshold; and
performing matching retrieval in the second knowledge base according to at least the key field to obtain a second knowledge document, wherein the matching retrieval is used to query, in the second knowledge base, a knowledge document that comprises the key field;
wherein the target knowledge document comprises the first knowledge document and the second knowledge document.

8. The knowledge question and answer method according to claim 1, wherein the business knowledge documents in the second knowledge base are stored by:
acquiring a plurality of business knowledge documents through different channels;
performing splitting processing on each of the plurality of business knowledge documents to obtain a business knowledge fragment;
performing vectorization processing on the business knowledge fragment to obtain a knowledge fragment vector; and
storing the knowledge fragment vector into the second knowledge base.

9. A non-transitory computer-readable medium storing thereon a computer program, wherein the computer program, when executed by a processing apparatus, causes the processing apparatus to performs a knowledge question and answer method, which comprises:
acquiring a target question input by a user in a natural language;
retrieving, by a machine learning model, in a first knowledge base according to the target question to obtain a target data field for answering the target question, and retrieving in a second knowledge base according to the target question to obtain a target knowledge document for answering the target question, and determining a target answer to the target question according to the target data field and the target knowledge document, wherein the first knowledge base is configured to store metadata fields of a business data table composed of business data, and the second knowledge base is configured to store business knowledge documents; and
displaying the target answer to the user.

10. The non-transitory computer-readable medium according to claim 9, wherein the determining the target answer to the target question according to the target data field and the target knowledge document comprises:
determining content relevance between the target question and the target data field and content relevance between the target question and the target knowledge document respectively;
determining a preset number of pieces of knowledge data from the target data field and the target knowledge document according to the content relevance between the target question and the target data field and content relevance between the target question and the target knowledge document, wherein content relevance corresponding to the preset number of pieces of knowledge data is greater than content relevance corresponding to knowledge data other than the preset number of pieces of knowledge data in the target data field and the target knowledge document; and
determining the target answer to the target question according to the preset number of pieces of knowledge data.

11. The non-transitory computer-readable medium according to claim 10, wherein the determining the content relevance between the target question and the target data field and the content relevance between the target question and the target knowledge document respectively comprises:
inputting the target question, the target data field and the target knowledge document into a relevance model to obtain the content relevance between the target question and the target data field and the content relevance between the target question and the target knowledge document respectively, wherein the relevance model is configured to output, according to a question and a data field that are input, content relevance between the question and the data field, and output, according to a question and a knowledge document that are input, content relevance between the question and the knowledge document.

12. The non-transitory computer-readable medium according to claim 9, wherein the method further comprises:
performing intention recognition on the target question to obtain an intention recognition result,
wherein the determining the target answer to the target question according to the target data field and the target knowledge document comprises:
determining knowledge data for answering the target question from the target data field and the target knowledge document according to the intention recognition result; and
determining the target answer to the target question according to the knowledge data.

13. The non-transitory computer-readable medium according to claim 9, wherein the method further comprises:
performing intention recognition on the target question to obtain an intention recognition result;
wherein the determining the target answer to the target question according to the target data field and the target knowledge document comprises:
determining a target template from a preset prompt template according to the intention recognition result;
generating a target prompt according to the target data field, the target knowledge document, the target question and the target template, wherein the target prompt is used to instruct the machine learning model to determine the target answer to the target question according to the target data field and the target knowledge document; and
inputting the target prompt into the machine learning model to obtain the target answer to the target question.

14. The non-transitory computer-readable medium according to claim 9, wherein the retrieving, by the machine learning model, in the first knowledge base according to the target question to obtain the target data field for answering the target question comprises:
extracting a key field from the target question by the machine learning model;
performing semantic recall in the first knowledge base according to at least the key field to obtain a first data field, wherein the semantic recall is used to query, in the first knowledge base, a data field with semantic similarity greater than a preset threshold to the key field; and
performing matching retrieval in the first knowledge base according to at least the key field to obtain a second data field, wherein the matching retrieval is used to query, in the first knowledge base, a data field equal to the key field;
wherein the target data field comprises the first data field and the second data field.

15. The non-transitory computer-readable medium according to claim 9, wherein the retrieving in the second knowledge base according to the target question to obtain the target knowledge document for answering the target question comprises:
extracting a key field from the target question by the machine learning model;
performing semantic recall in the second knowledge base according to at least the key field to obtain a first knowledge document, wherein the semantic recall is used to query, in the second knowledge base, a knowledge document that comprises a similar field, and semantic similarity between the similar field and the key field is greater than a preset threshold; and
performing matching retrieval in the second knowledge base according to at least the key field to obtain a second knowledge document, wherein the matching retrieval is used to query, in the second knowledge base, a knowledge document that comprises the key field;
wherein the target knowledge document comprises the first knowledge document and the second knowledge document.

16. The non-transitory computer-readable medium according to claim 9, wherein the business knowledge documents in the second knowledge base are stored by:
acquiring a plurality of business knowledge documents through different channels;
performing splitting processing on each of the plurality of business knowledge documents to obtain a business knowledge fragment;
performing vectorization processing on the business knowledge fragment to obtain a knowledge fragment vector; and
storing the knowledge fragment vector into the second knowledge base.

17. An electronic device, comprising:
a storage apparatus storing thereon a computer program; and
a processing apparatus, configured to execute the computer program in the storage apparatus to implement a knowledge question and answer method, which comprises:
acquiring a target question input by a user in a natural language;
retrieving, by a machine learning model, in a first knowledge base according to the target question to obtain a target data field for answering the target question, and retrieving in a second knowledge base according to the target question to obtain a target knowledge document for answering the target question, and determining a target answer to the target question according to the target data field and the target knowledge document, wherein the first knowledge base is configured to store metadata fields of a business data table composed of business data, and the second knowledge base is configured to store business knowledge documents; and
displaying the target answer to the user.

18. The electronic device according to claim 17, wherein the determining the target answer to the target question according to the target data field and the target knowledge document comprises:
determining content relevance between the target question and the target data field and content relevance between the target question and the target knowledge document respectively;
determining a preset number of pieces of knowledge data from the target data field and the target knowledge document according to the content relevance between the target question and the target data field and content relevance between the target question and the target knowledge document, wherein content relevance corresponding to the preset number of pieces of knowledge data is greater than content relevance corresponding to knowledge data other than the preset number of pieces of knowledge data in the target data field and the target knowledge document; and
determining the target answer to the target question according to the preset number of pieces of knowledge data.

19. The electronic device according to claim 18, wherein the determining the content relevance between the target question and the target data field and the content relevance between the target question and the target knowledge document respectively comprises:
inputting the target question, the target data field and the target knowledge document into a relevance model to obtain the content relevance between the target question and the target data field and the content relevance between the target question and the target knowledge document respectively, wherein the relevance model is configured to output, according to a question and a data field that are input, content relevance between the question and the data field, and output, according to a question and a knowledge document that are input, content relevance between the question and the knowledge document.

20. The electronic device according to claim 17, wherein the method further comprises:
performing intention recognition on the target question to obtain an intention recognition result,
wherein the determining the target answer to the target question according to the target data field and the target knowledge document comprises:
determining knowledge data for answering the target question from the target data field and the target knowledge document according to the intention recognition result; and
determining the target answer to the target question according to the knowledge data.
